(19) United States
(12) Patent Application Publication
(10) Pub. No.: US 2004/0213709 A1
(43) Pub. Date: Oct. 28, 2004

(54) Apparatus used on photoreactive plates

(76) Inventor: Larry V. Presley, Tampa, FL (US)

Correspondence Address: GREENBERG & LIEBERMAN, 314 PHILADELPHIA AVE., TAKOMA PARK, MD, 20912, US

(21) Appl. No.: 09/682,509

(22) Filed: Sep. 11, 2001

Related U.S. Application Data
(60) Provisional application No. 60/231,702, filed on Sep. 11, 2000.

(51) Int. Cl. B01J 19/08

(52) U.S. Cl. 422/186.3

(57) ABSTRACT

A hollow cylindrical tube runs the length of a photoreactor. The tube is positioned below the photoreactor or the photoreactor sits atop the device. The cylindrical tube has a slotted opening on top. The photoreactor fits into the slotted opening and is supported by the slotted opening. There is added reinforcement through the use of support braces on either side of the slotted opening along the cylindrical tube. These L-shaped braces add strength and support to the upright plates sitting in the slotted opening. The braces are aid in the attachment of the cylindrical tubing and the photoreactor plates.

### CROSS REFERENCE TO RELATED APPLICATIONS

Priority is hereby claimed to Provisional Patent Application No. 60/231,702 filed on Sep. 11, 2000.

### BACKGROUND OF INVENTION

Many companies and industries produce or use chemicals that are detrimental to the environment if released into the water systems or air with proper treatment. In the United States we have series of environmental restrictions that require businesses to catalogue, diffuse and treat the waste water before it is released into the environment, and is regulated by the Environmental Protection Agency. The use of photocatalysis in waste water management can filter the waste and erradicate it before the water reintroduction to the environment.

U.S. Pat. No. 5,924,437 issued to Young on July 20, 1999 shows an External shutoff valve for fire hydrants. Young″s invention is unlike the present invention because it is an emergency shut off valve method for fire hydrants that have been activated by accident, does not provide a means for treating or transporting waste water, and does not provide for photo reaction plates or any photocatalysis means.

U.S. Pat. No. 5,615,703 issued to Kopp on April 1, 1997 shows a plastic valve with inlet conduit extension. Kopp″s invention is unlike the present invention because it has no means of attachment to a photoreactor cell, it is not intended to expediate a waste water purification system, and it has no described means for separating toxic components from benign components in waste water.

U.S. Patent no. 1,667,034 issued to Hatton, Jr. on Apr. 24,1928 shows a sealing valve for gas lines. Hatton″s invention is unlike the present invention because, it has no means for attaching to a photoreactor cell, and it is not intended for use in waste water treatment.

U.S. Pat. No. 924,041 issued to Corlew on Jun. 8, 1909 shows a hose hydrant Corlew″s invention is unlike the present invention because, it would not function for use in the photocatalysis process, it does not have a means for treating waste water to separate the toxic parts from the benign parts, and has a tapered end and no removable cap.

Therefore a need has been established for a tubing system for waste water treatment and photocatalysis use.

### SUMMARY OF INVENTION

A large problem throughout industrialization has been waste management. Heavy reliance throughout the years on pesticides and chemicals in agriculture and many other industries have caused industries and communities throughout the country to struggle with the treatment of waste water. Processing waste water in an environmentally sound and economical manner is of concern to many organizations. Photocatalysis is a well known scientific process with a promising application in waste water management. Photocatalysis involves bombarding a photoreactive compound with ultraviolet light. The compound becomes highly reactive; solar energy is converted into chemical energy through the transformation of the photoreactive compound into reactive radicals. The highly reactive radicals attack oxidizable water pollutants by breaking their molecular bonds. Non toxic final products like water, carbon dioxide and weak acids are the end result.

A method for utilizing photocatalysis in waste water management is through the use of titanium dioxide as a photocatalyst. Titanium dioxide is mixed in with the waste water. This solution is processed through a series of flat plate photoreactors. For optimum use of the photoreactors, the solution should be evenly distributed over the flat plates. This would maximize the amount of solution in contact with the flat plate photoreactors. To distribute the incoming solution from a piped source to the rectangular photoreactors, an intermediary device is required. The present invention is a device which directs the intake flow of waste water to photoreactor plates.

DEFINITIONS: photocatalysis—to increase the rate of a chemical reaction induced by material unchanged chemically at the end of the reaction with ultra violet light as the energy source for the reaction. photocatalyst—an agent which provokes or speeds up a reaction with ultra violet light as the energy source to activate the agentphotoreactor—a device which creates a photochemical reaction. polymerizable—a chemical reaction in which two or more molecules combine to form larger molecules that contain repeating structural units.

The present invention is a hollow cylindrical tube. The cylindrical tube runs the length of a photoreactor. The tube is positioned below the photoreactor or the photoreactor sits atop the device. The cylindrical tube has a slotted opening on top. The photoreactor fits into the slotted opening and is supported by the slotted opening. There is added reinforcement through the use of support braces on either side of the slotted opening along the cylindrical tube. These L-shaped braces add strength and support to the upright plates sitting in the slotted opening. The braces are aid in the attachment of the cylindrical tubing and the photoreactor plates.

Since fluids flow through the cylindrical tubing and the photoreactor plates, a water tight seal is necessary between the tubing and the plates. A polymerizable cement and solvent is used in the slotted opening of the cylindrical tubing. This helps in creating a water tight seal between the cylindrical tubing and the photoreactor plates. The braces attached to the cylindrical tubing and the photoreactor plates also help in creating a seal. With a water tight connection, fluid can flow through the tubing without contaminating the surrounding area.

Waste water enters the cylindrical tubing from a piped source. One end of the cylindrical tube connects to this piped intake source. The waste water flows through the cylindrical tube and fills the photoreactor plates. The other end of the cylindrical tube acts a blind end when plugged or can be hooked up in series with other tubing. A manifold at the top of the photoreactor plates redistributes the processed water.

Accordingly, it is the object of this invention to provide a system to optimize fluid flow to photoreactorplates.

### BRIEF DESCRIPTION OF DRAWINGS

FIG. 1 shows a cut away side view of the present invention.

FIG. 2 shows a top view of the manifold.

FIG. 3 shows an end view of the tubing member.

FIG. 4 shows the hosing clamp of the present invention.

FIG. 5 shows a cut away view of the manifold.

FIG. 6 shows a cut away section of the tubing attached to the hose clamp.

FIG. 7 shows the present invention and the steps for assembling such.

### DETAILED DESCRIPTION

Photocatalysis is a well known process which occurs when an aqueous solution containing a hydrocarbon compound and a photocatalyst agent such as titanium dioxide is exposed to ultraviolet rays. When the ultraviolet waves strike the titanium dioxide hydroxol radicals are produced. The hydroxol radicals interact with the hydrocarbons to produce carbon dioxide, water, and hydrochloric acid. Therefore the photocatalyst can break down waste water into, benign, or recycable compounds.

The present invention is an attachable device to direct the intake flow to photoreactor plates. The device is a cylindrical tube which is hollow. Along the apex of the tube is a slotted opening. A photoreactive plate sits in this slotted opening. Along the right side of the slotted opening are supporting braces. The supporting braces are L-shaped.

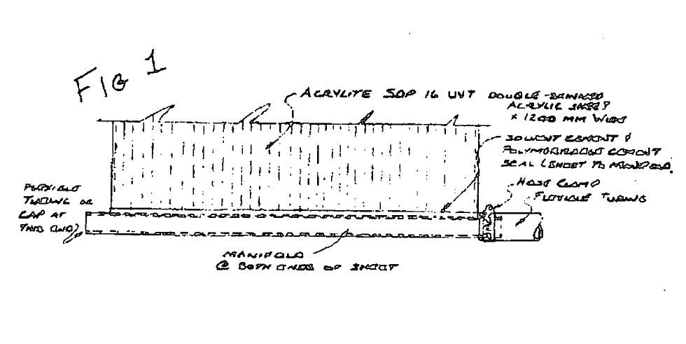

FIG. 1 shows a cut away side view of a possible embodiment of the present invention. The tubing is manufactured of an Acrylic SOP of 16 wt, which is a double skinned acrylic sheet that is approximately 1200 mm wide. The acrylic sheets assist in maintaining even flow distribution through the channels as shown. Also the skin of the acrylic sheeting is so thin that the majority of UV radiation passes through the skin, and reacts with the titanium dioxide in the solution therein. A 30 weight cement is used to seal the sheet to the manifold. At the end of the manifold is a hose clamp and fusible tubing. the manifold attaches to both ends of the acrylic sheet. At the opposite end of the manifold from the fusible tubing, is flexible tubing or a cap at that end depending on use.

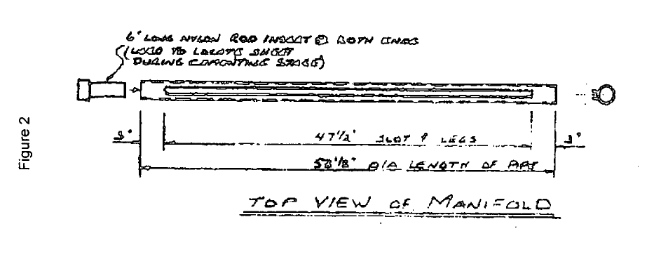

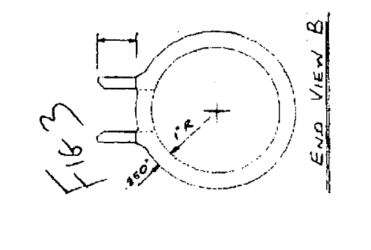

FIG. 2 shows a top view of the manifold. There is a 6″nylon rod entered into each end of the tubing to locate the cement sheeting. The tubing is 52.5″long and the interior cement sheeting section is 47.5″ long. FIG. 3 shows an end view of the tubing member which has a 1″ radius.

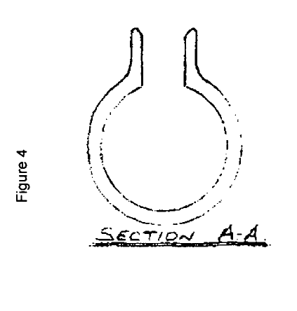

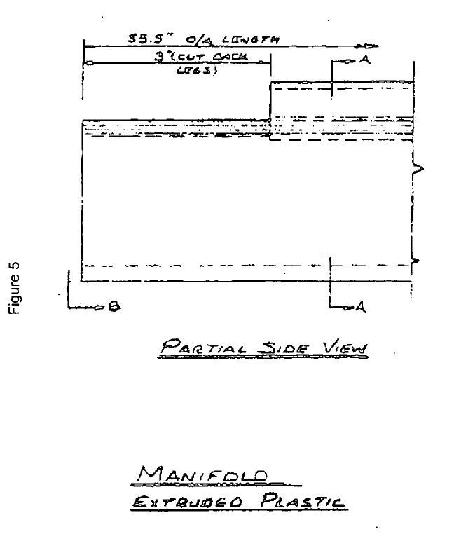

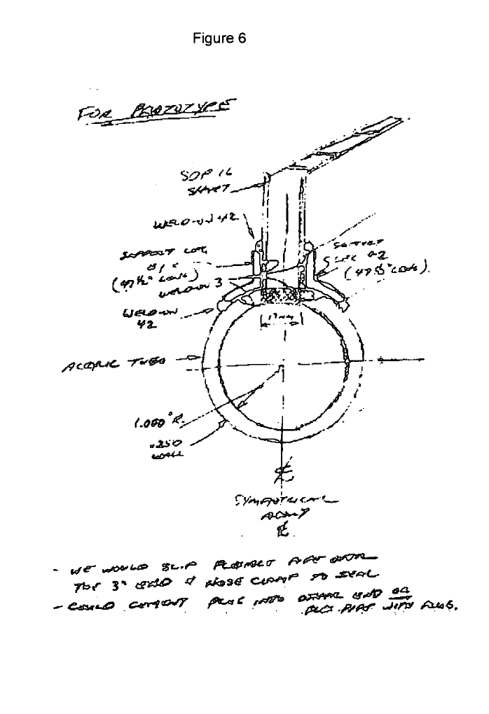

FIG. 4 shows the hosing clamp of the present invention. The hosing clamp has flanges as shown to help clamp and steady it to the tubing member. FIG. 5 shows a cut away view of the manifold. At one end of the manifold is a 3″ cut back. The manifold is 53.5″in length. FIG. 6 shows a cut away section of the tubing attached to the hose clamp. At the top of FIG. 6, is the acrylic SOP as shown in FIG. 1, as attached to the hose clamp shown in FIG. 4. The hose clamp is securely welded securely on to the acrylic SOP. The wall of the acrylic sheet is 0.250 wide in this embodiment and the tubing member is symmetrical in nature.

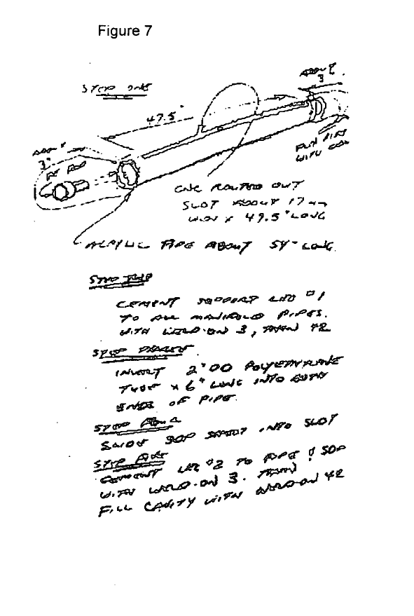

FIG. 7 shows the present invention and the steps for assembling such. The tubingmember is shown at an approximate length of 54″there is a cut away of each end of the tubing member of approximately 3″. There is a capping member shown that can attach to one end of the present invention. Around the center of the tubing is a groove of approximately 17 mm. There is a cement support at 3 and 47 inches to secure the manifold. A polyurethane material is then inserted in the interior of the tubing, and in this embodiment is 6″long. The SOP is then inserted in one end of the pipe fashioned as a slot. This slot acts as a flow header into the tubing. The end with the SOP is then cemented and welded.

The first end of a supporting brace is attached to the cylindrical tubing. The second end of a supporting brace rests on the wall of the photoreactive plate once the plate is placed in the opening. The second end of the supporting brace is welded to the wall of the photoreactive plate once the photoreactive plate is in the slotted opening. Along the left side of the slotted opening are supporting braces also. As on the right, the supporting braces is attached to the cylindrical tubing and is welded to the wall of the photoreactive plate once it is in place. The supporting braces and the slotted opening add strength and a seal to the upright photoreactive plate. A suitable solvent and polymerized cement provide additional strength at this joint and a water tight seal between the surfaces.

Waste water from a piped in source enters the first end of the cylindrical tube. The first end of the cylindrical tube fits the end of the piped source through standard piping connectors. The first end of the cylindrical tube acts as a conduit for the waste water. The waste water can fill the photoreactive plates. The first end of the cylindrical tube acts as the intake point for waste water to the system. The second end of the tubing can be plugged or joined in a series to other tubing.

It is to be understood that the present invention is not limited to the sole embodiment described above.

1. A tubing member for use with waste water management, comprising:
a main hollow body, having a first and second end;
a photoreactor plate placed in communication with said first end;
a series of bracing members attached to the exterior of said main hollow body;
a slotted opening in fixed communication with said first end; and
a series of tubing communicating with said second end of said main body.
